(19) United States
(12) Patent Application Publication
(10) Pub. No.: US 2002/0116279 A1
(43) Pub. Date: Aug. 22, 2002

(54) Online wine sale process

(76) Inventor: Nicholas Thomas Nobilo, Auckland (NZ)

Correspondence Address: JACOBSON, PRICE, HOLMAN & STERN, PROFESSIONAL LIMITED LIABILITY COMPANY, 400 SEVENTH STREET, N.W., WASHINGTON, DC, 20004, US

(21) Appl. No.: 09/788,662

(22) Filed: Feb. 21, 2001

(51) Int. Cl. G06F 17/60

(52) U.S. Cl. 705/26

(57) ABSTRACT

A process and system for online sale of wine by wine producers where purchasers join a club having membership benefits which include obtaining a legal interest in one or more vines and the receipt of wine made from the vineyard in which such vines are located. Wine is supplied from consecutive vintages during the term of club membership which also determines the term of the legal interest in the vines. The wine may be labelled with labels personal to each club member.

### FIELD

This invention relates to a method of online promotion and sale of products made from harvested crops, in particular grape wine.

### BACKGROUND TO THE INVENTION

Online sites for sales of wine are now well-known. Examples are, eVineyard, wine.com, and Fine Wine Online. Some websites offering wine for sale are operated by wine producers exclusively or predominantly promoting and/or selling their own wine. Examples are beringer.com, Hunters.co.nz. However, while standard promotional schemes are sometimes used to attract purchasers, including membership of a vineyard “club”, there are few, if any, that offer the purchaser the prospect of a tangible interest in the vineyard from which at least some of the wines originate.

### SUMMARY OF THE INVENTION

It is an object of the present invention to provide a process and system for the online sale of wine by wine producer vendors which provides purchasers with a stake in the vineyard.

The invention in one aspect consists in a computer system for online sale of wine by a wine producer vendor, who controls one or more designated vineyards, to members of a wine purchasing scheme where members are provided with benefits in addition to receiving wine, said system comprising:

means for the online promotion of membership of said wine purchasing scheme and its benefits;

means for receiving online applications for membership of the scheme, and a membership fee using a secure funds transfer system;

means for storing member data;

means for storing data identifying each vine in each designated vendor vineyard;

means for allocating a legal interest in a different one of said vines to each accepted member;

means for supplying documentation evidencing a member's legal interest in a vine to each member;

means for recording in the form of forward orders from each member a quantity of wine made from the vineyard in which the member holds a vine from each vintage for a designated number of years, each order being for different vintages of said wine; and

means for triggering the delivery of each order to each member in the year each vintage is released.

In a second aspect the invention consists in a process for online sale of wine by a wine producer vendor, who controls one or more designated vineyards, comprising the steps of:

establishing a wine purchasing club;

promoting membership of said wine purchasing club and its benefits online;

accepting online applications for membership of the club, and an associated membership fee using a secure funds transfer system;

storing member data;

storing data identifying each vine in each designated vendor vineyard;

allocating online a legal interest in a different one of said vines to each accepted member;

supplying documentation evidencing a member's legal interest in a vine to each member;

recording in the form of forward orders from each member a quantity of wine made from the vineyard in which the member holds a vine from each vintage for a designated number of years, each order being for different vintages of said wine; and

triggering the delivery of each order to each member in the year each vintage is released.

According to the present invention persons acquire wine over a period of time as a result of membership of an online club which not only entitles him to receive wine, but through membership acquire a legal interest in a wine producing vine. They thus “own” a vine, the progress of which they may follow online during the viticultural calendar. Additionally, labels on wine produced for members from the vineyard where the member “owns” a vine may be personalised for each member.

### BRIEF DESCRIPTION OF THE DRAWINGS

FIG. 1 is a block diagram of the online business process of the present invention.

### DESCRIPTION OF THE PREFERRED EMBODIMENTS OF THE INVENTION

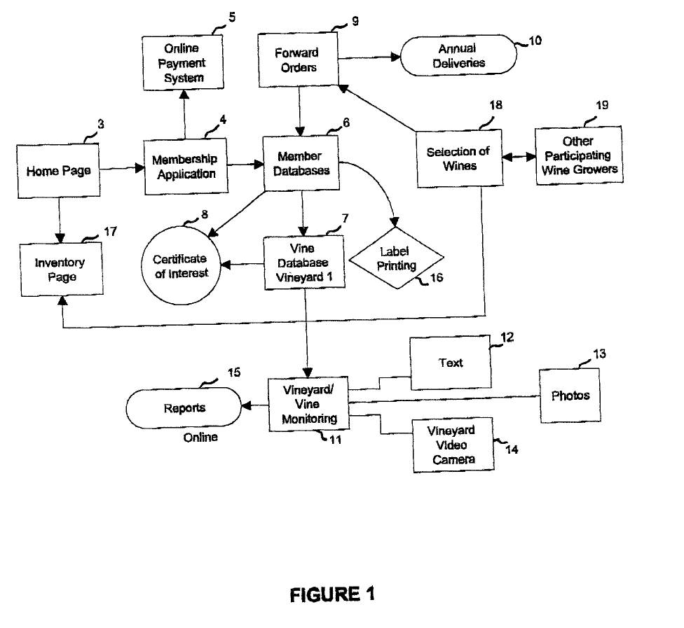

The primary functions of the e-commerce business process of the present invention are shown in FIG. 1. In the preferred embodiment the preferred product of this commerce is wine and the operator is a wine producer. The overall business process underlying the present invention includes various conventional manual processes in addition to the online processes and these will not be described in any detail.

According to the present invention a targeted selection of the public is invited to become a member of a club which provides members with wine and other benefits, including a tangible interest in the vineyard which produces at least some of the wine provided to members. The essential processes are largely implemented on computer systems, namely a website and a back-office system.

Referring now to FIG. 1, potential members visit website homepage 3 as a result of print media promotion or through the use of search engines. The manner in which the club functions and the benefits of becoming a member are promoted either on the home page or a directly hyperlinked ancillary page. On clicking on an appropriate button a potential member is presented with a membership application page (4) which is used to capture the name and address of each member and other useful data. A membership fee is required to be paid and payment of this fee is preferably captured by a conventional secure online payment system (5). Membership is for a specific term in the future, preferably three years, and must be renewed beyond that term, for example by annual subscription. Member data is stored in a back office member database (6).

Members may be offered wine from one or more vineyards under the control of the wine producing vendor. A back office vine database (7) contains identification and location data for each vine in each vendor controlled vineyard. Members may belong to clubs associated with one or more vendor controlled vineyards.

To simplify explanation, assume a member elects to become a member of a club associated with vendor's “vineyard 1”. A single membership recorded in member database (6) will cause vine database (7) to be interrogated to provide the next available “unowned” vine in vineyard 1. The identity of that vine will be associated with that member in the member database. The member is provided either online or offline with a certificate (8) or other documentation evidencing his interest in the allocated vine. The precise nature of the legal interest in one of the vendor's vines is a compromise between providing club members with tangible legal interests while allowing freedom of the vendor property control and to manage his vineyard for the purpose of producing wine, including for non-members. Under the present invention a typical legal interest which might be provided to members is in the form of a licence to rights in the vine.

Membership of a vineyard club entitles members to an allocation of wine from that vineyard for three successive vintages (where the membership term is for three years), although delivery of the first vintage may not occur within the first year of membership. Membership entitles members to a quantity of wine from the vineyard for three successive vintages and this quantity may be one or more bottles. The back office system thus contains a module (9) which effectively extracts and stores forward orders of wine to members for future vintages. As each wine from each vintage is released the system accepts a release date and triggers the outputting of documentation (10) which leads to delivery of members orders for that vintage. The warehouse where dispatch takes place from may be remote from the website and may indeed be in a different country, as may the vineyard from which the wines are made.

To provide other tangible interests in the members vine and the vineyard in which it is located, regular reporting information is made available on the website as to progress of the vines and the vineyard as a whole throughout the viticultural year. Thus a vineyard/vine monitoring database (11) receives and stores text inputs (12) and preferably may also receive up to date still graphics (13) and even output from a vineyard located video camera (14). The monitoring data is made available as reports or other output on appropriate website pages (15). Thus members by accessing the website are able to monitor the progress of the vineyard and/or their vine in its annual cycle of producing grapes for the production of wine to be distributed to members.

Preferably wine delivered to members which is produced from vineyards in which they “own” vines is labelled with labels personalised for each member. For example the label may include text such as “Bottled for [name of member]”. To facilitate this function, batch output (16) is extracted from the member database (6) annually and either used directly by a label printer or provided in paper form to a third party printer.

The wine acquisition club may be operated to provide members with only wines made from vineyards controlled by the vendor as described above, but preferably it is also used to make available specially selected wines (18) from other wine producers (19). For example, part of club benefits may include one or more bottles of selected wines from several third party wine producers. Where this is the case, these wines will be included on the site inventory page (17) which in turn will be hyperlinked to pages describing each third party wine, its wine maker and the processes used by that winemaker. The offering of specially selected and endorsed third party wines is a particularly useful option where only one vendor operated vineyard is available to supply wines to club members. It will be appreciated that each vineyard may contain only one grape variety and the ability to offer more than one variety enhances the benefits of membership.

I claim:

1. A computer system for online sale of wine by a wine producer vendor, who controls one or more designated vineyards, to members of a wine purchasing scheme where members are provided with benefits in addition to receiving wine, said system comprising:
means for the online promotion of membership of said wine purchasing scheme and its benefits;
means for receiving online applications for membership of the scheme, and a membership fee using a secure funds transfer system;
means for storing member data;
means for storing data identifying each vine in each designated vendor vineyard;
means for allocating a legal interest in a different one of said vines to each accepted member;
means for supplying documentation evidencing a member's legal interest in a vine to each member,
means for recording in the form of forward orders from each member a quantity of wine made from the vineyard in which the member holds a vine from each vintage for a designated number of years, each order being for different vintages of said wine; and
means for triggering the delivery of each order to each member in the year each vintage is released.

2. A computer system for online sale of wine according to claim 1 wherein each said forward order includes a quantity of selected wines not made by the wine producer vendor, but which are selected by said vendor, and wherein said means for the online promotion of said wine purchasing scheme include information on said selected wines.

3. A computer system for online sale of wine according to either of claims 1 or 2 including means for personalising labels of wine produced from the vineyard in which members have an interest in the vines, which means access member and forward order data and print selected member details on the labels of each bottle of wine making up said quantity allocated to each member.

4. A process for online sale of wine by a wine producer vendor, who controls one or more designated vineyards, comprising the steps of:
establishing a wine purchasing club;
promoting membership of said wine purchasing club and its benefits online;
accepting online applications for membership of the club, and an associated membership fee using a secure funds transfer system;
storing member data;
storing data identifying each vine in each designated vendor vineyard;
allocating online a legal interest in a different one of said vines to each accepted member;
supplying documentation evidencing a member's legal interest in a vine to each member;
recording in the form of forward orders from each member a quantity of wine made from the vineyard in which the member holds a vine from each vintage for a designated number of years, each order being for different vintages of said wine; and
triggering the delivery of each order to each member in the year each vintage is released.

5. A process for online sale of wine according to claim 4 wherein a quantity of selected wines not made by the wine producer vendor are selected by said vendor each year, wherein the online promotion of said wine purchasing club includes information on said selected wines, and said quantity of selected wines is added to each member's forward order.

6. A process for online sale of wine according to either of claims 5 or 6 including the steps of personalising labels of wine produced from the vineyard in which members have an interest in the vines, by accessing said member and forward order data and printing selected member details on the labels of each bottle of wine making up said quantity allocated to each member.
